(19) United States
(12) Patent Application Publication
(10) Pub. No.: US 2004/0117374 A1
(43) Pub. Date: Jun. 17, 2004

(54) Customized design portfolio integrating IP libraries and technology documents

(76) Inventors: Lup Cheong Patrick Hung, Hsin-Chu (TW); Ming-Hsin Thomas Chen, Hsin-Chu (TW); Feng-Mei Yang, Hsin-Chu (TW); Yu Yong Shen, Taipei (TW); Chun-Cho Chen, Hsin-Chu (TW)

Correspondence Address: SLATER & MATSIL, L.L.P., 17950 PRESTON RD, SUITE 1000, DALLAS, TX, 75252-5793, US

(21) Appl. No.: 10/321,139

(22) Filed: Dec. 16, 2002

(51) Int. Cl. G06F 17/30; G06F 7/00

(52) U.S. Cl. 707/10

(57) ABSTRACT

A system for customizing a design portfolio for an IC product. An IP library management server allows IP providers to upload IP libraries and subsequently verify and sort the uploaded IP libraries. A technology document server allows a foundry to upload technology documents and verify and sort the uploaded technology document. A database stores the verified technology documents, IP libraries, and meta information associated therewith. A design portfolio management server provides a terminal user the verified technology documents and IP libraries for creation of a customized design portfolio thereby and further monitoring the customized design portfolio to send notification when the portfolio status changes.

### BACKGROUND OF THE INVENTION

1. Field of the Invention

The present invention relates to design document integration and management, and in particular to a design document management system and a method for integrating IP libraries and technology documents regarding IC design from diverse sources and allowing customized portfolios to monitor documents therein.

2. Description of the Related Art

The computer and electronics industries were once led by large, vertically integrated firms. These monolithic companies included divisions that designed and fabricated general purpose or custom integrated circuits (IC chips) on their own. Lately, dedicated foundry companies have arisen. These foundries do not participate in IC design, but only provide fabrication service to IC designers who cannot afford to build costly semiconductor factories. Fabless design houses or design companies, which do not fabricate their IC products themselves, consequently focus on developing and writing their own software tools and utilities required to effectively perform various engineering tasks. Therefore, after years of development, some design houses or design companies have developed a large library of the components and circuits designs required to build and integrate their proprietary systems and chips. Such circuit designs commonly comprise what is referred to as an intellectual property library (IP library).

In recent years, because of the increasing level of technical complexity and the need to differentiate product offerings, many companies have become specialized in particular applications of semiconductors. Moreover, because of the increasingly contracted time-to-market requirements, design companies are also compelled to be more specialized in particular business areas. This, in turn, has pressured IC designers to complete their design tasks in shorter periods of time, resulting in shorter overall product cycles for integrated circuits. To meet this challenge, more and more design houses rely on a hierarchical approach to IC design. In this approach, a complex chip is segmented into a number of component circuits, each of which may be further segmented into subcomponents, and so on. For example, an integrated circuit containing a “system on a chip” (SOC) is segmented into a memory component, a CPU component, a graphics component, etc. The CPU component may be further subdivided into ALU, control logic, cache, etc. Likewise, the memory component may be further subdivided into a basic memory cell which is replicated many times, control logic, etc. Dividing a complex chip into a number of simpler circuits achieves several purposes. First, the hierarchical approach provides a systematic approach to designing complex chips. Second, designing each of the components is a more manageable task than designing the entire chip at once. Third, the design time for the chip is reduced because all of the components can be designed in parallel.

It is therefore increasingly popular to purchase or license some or all of these components from third parties who have previously designed the component, rather than designing the components from the initial stages. Such circuit components are often referred to as “IP blocks” or “IP cores” with the third party being an “IP provider”. The IP approach results in faster design times and lower costs in some ways. The faster design time results from integration of an IP block into a chip, which typically requires less time than designing the block from the initial stages. The lower cost results from the IP provider typically having more expertise in the circuit specialty, engendering enhanced efficiency in designing the IP block.

Although there is abundant 3rd party IP available on the market, IC designers often encounter other problems dealing with the technology information. One problem is that IC designers have to spend time contacting various IP vendors to obtain required IP blocks or IP cores. Moreover, during an IC design cycle, designers may pre-select numerous IP blocks or cores as candidates from diverse individual vendors rather than immediately determining which IP is to be adopted. It may be troublesome and a burden for IC designers to manage IP provided by diverse individual IP vendors or providers.

Another problem occurs when IC designers cooperate with several IP vendors, they have to spend time to obtain information from the diverse individual vendors. When IC vendors amend or update their IP blocks or cores, IC designers can only passively obtain the latest information from the vendors. Moreover, IC designers have to evaluate the impact and compatibility of multiple versions after receipt thereof.

Since a new IC product is usually developed by a design team, it is also important for members of the design team to refer to the same version of IP information during the design cycle. However, this is difficult to achieve because IP information may originate with, and be updated from, diverse individual IP vendors.

### SUMMARY OF THE INVENTION

Accordingly, an object of the present invention is to provide a system and method flow to manage and classify IP libraries provided by various IP providers.

Another object of the present invention is to provide an online system allowing IC designers to build a customized IP portfolio with verified and classified access to technology documents and IP libraries.

In accordance with the present invention, a system for IP library management is provided, comprising an IP management server and database for storing the IP libraries. Preferably, the IP management server is programmed with a login module allowing IP providers to upload and maintain IP libraries and sort the uploaded IP libraries by certain criteria, a gating module for reviewing the uploaded IP libraries to assess approvability, and a posting module for posting the approved IP libraries.

A method for IP library management is provided accordingly, comprising the following steps. An IP library and information associated therewith is provided and then sorted by predetermined criteria. The IP library and the information associated therewith are reviewed to assess approvability. Finally, the approved IP library and the information associated therewith are approved for posting.

The present invention further provides a customized design portfolio management system, comprising a database storing a plurality of pre-classified technology documents, IP libraries and meta information associated therewith, and a design portfolio management server providing a terminal user with access to the verified technology documents and IP libraries in the database for creation of a customized design portfolio thereby, and further monitoring the customized design portfolio to send notification when the portfolio status changes.

Preferably, the design portfolio management server is programmed with a rule engine, search engine, security engine, and notification engine, allowing a terminal user to create a customized design portfolio. The security engine authenticates user identification, the search engine searches the database according to the user's selection to create the customized design portfolio, the rule engine identifies the status of the documents and IP libraries in the document metadata database, and the notification engine monitors the status of the customized design portfolio, sending notification when the status changes.

A feature of the present invention is integration of IP libraries provided from various IP vendors and/or IP providers.

Another feature of the present invention is sorting of received IP libraries and technology documents by certain criteria, such as geometry and application.

Still another feature of the present invention is provision to IC designers of online maintenance and monitoring, and the ability to share customized IP and technology document portfolios.

Still another feature of the present invention is timely notification of portfolio owners of status changes.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 illustrates a general architecture of a system to integrate IP information provided by various IP vendors and to allow design companies to create customized portfolios regarding IP and design documents, according to a preferred embodiment of the present invention;

FIG. 2A illustrates a general system structure for IP management to manage IP libraries uploaded by IP vendors or providers according to a preferred embodiment of the present invention;

FIG. 2B illustrates a route to verify IP information provided by various IP vendors or providers according to the system structure in FIG. 2A;

FIGS. 3A and 3B illustrate a preferred user interface allowing IP providers to upload IP libraries in accordance with the present invention;

FIGS. 4A to 4C illustrate a preferred user interface allowing IP providers to update IP library versions in accordance with the present invention;

FIGS. 5A to 5F illustrate a preferred user interface allowing an IP reviewer to review newly created library in accordance with the present invention;

FIG. 6 illustrates dual site architecture for customized design portfolio management in accordance with the present invention;

FIG. 7 illustrates a Java-based system structure for design portfolio management in accordance with the present invention; and

FIG. 8 illustrates a preferred user interface with notification indicators in accordance with the present invention.

### DETAILED DESCRIPTION OF THE INVENTION

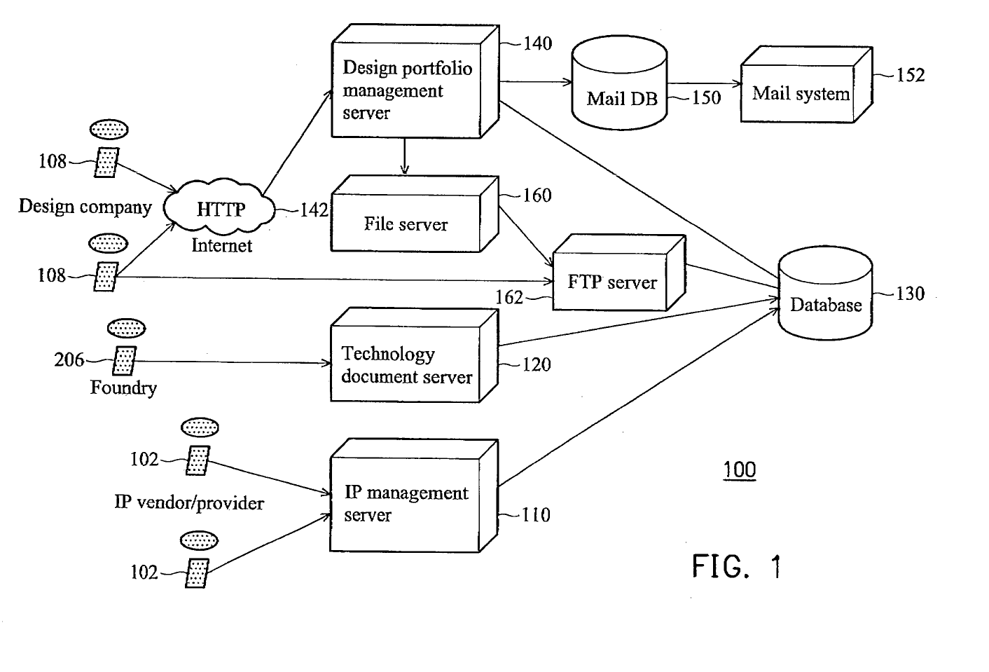

FIG. 1 illustrates a general architecture of a system 100 to integrate IP information provided by various IP vendors and allow design houses to create customized portfolios regarding IP and design documents according to a preferred embodiment of the present invention. In general, IP vendors or IP providers can log onto IP management server 110 to upload information regarding their IP. IP management server 110 will store uploaded IP into database 130 after verification. Preferably, system 100 also comprises technology document server 120, which allows a foundry 106 to upload technology documents regarding IC fabrication for IC designer reference. The verified technology documents can also be stored into database 130. The system 100 further comprises a design portfolio management server 140 for a design company 108 to log onto via the Internet. Design company 108 is allowed to create customized portfolios comprising selected IP libraries and/or technology documents regarding their design by way of the interface provided by the design portfolio management server 140. Preferably, authorized design company 108 is allowed to download information regarding IP libraries and/or fabrication technology from a FTP server 162. The design portfolio management server 140 further provides a notification mechanism to send e-mail to design company 108 by mail system 152 when the status of customized portfolios changes.

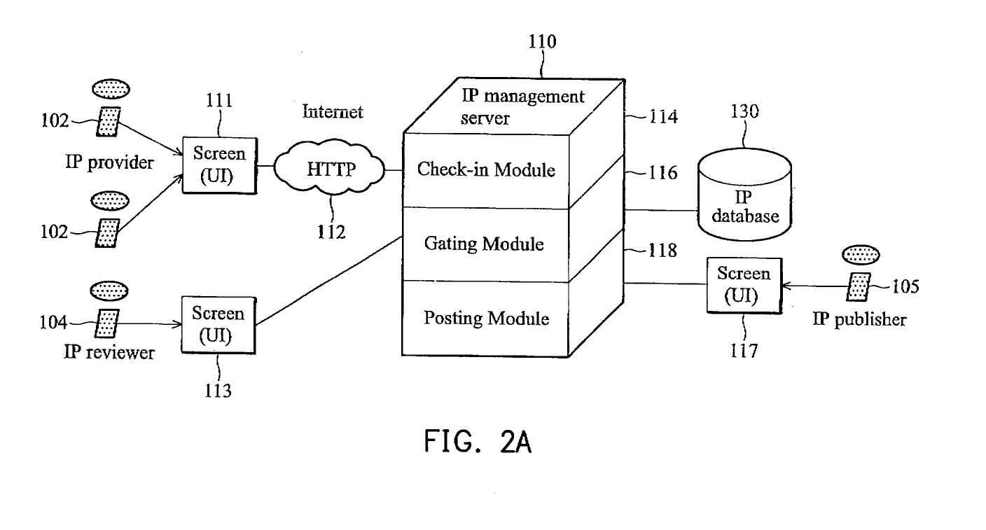

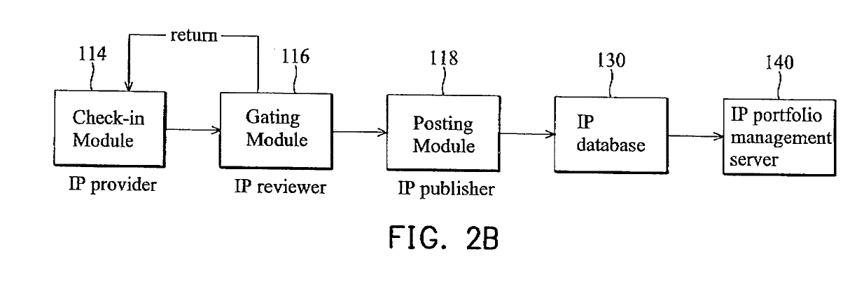

FIG. 2A illustrates a general system structure for the IP management of FIG. 1 to manage IP libraries uploaded by IP vendors or providers according to a preferred embodiment of the present invention. The IP management server 110 is programmed as a login module 114, a gating module 116, and a posting module 118. The IP management server 110 provides IP vendors or providers (102) user interface (UI) 111 to log in and upload IP information via the Internet 112.

FIG. 2B illustrates a route to verify IP information provided by various IP vendors or providers according to the system structure in FIG. 2A.

IP Library Login

Login module 114 allows IP providers to upload and maintain IP libraries and sort the uploaded IP libraries by certain criteria. An authorized IP provider 102 is allowed to log in via the user interface 111 for new library creation and/or library maintenance. In a preferred embodiment, the login module 114 allows the IP provider 102 to select library creation or maintenance via user interface 113. For new library creation, a basic information Web page is provided via which IP provider 102 can input requisite library information, such as name, type, version, and features.

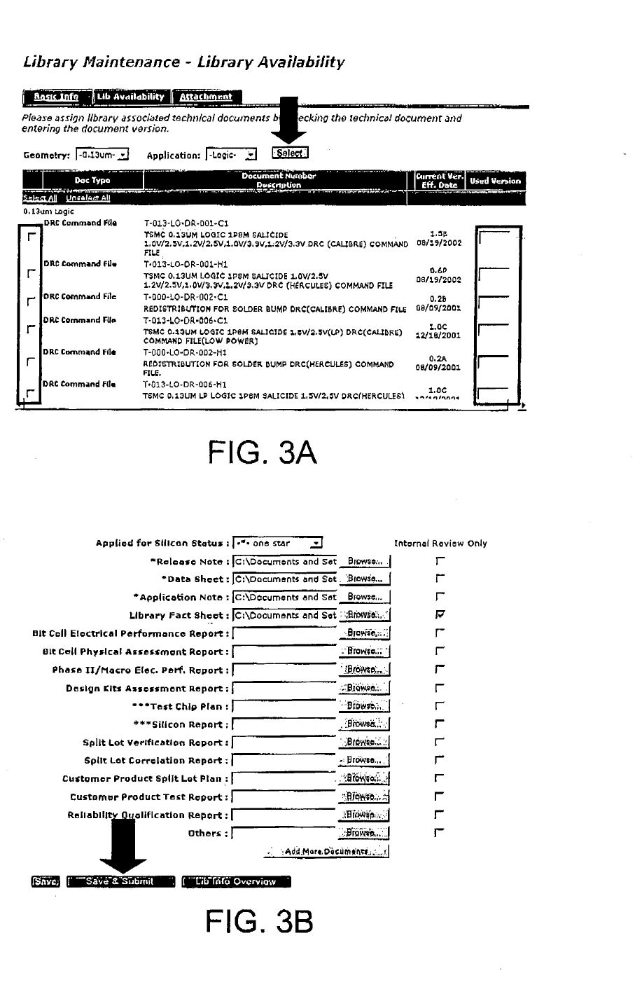

A library availability Web page, as shown in FIG. 3, is further provided after the basic information is entered and saved. The preferred library availability page, as shown in FIG. 3, allows IP provider 102 to assign the new library geometry, e.g. 0.35, 0.25, 0.18, or 0.13 μm, and application, such as logic, MS/RF, 1TRAM and so on. Preferably, the library availability page further allows IP provider 102 to assign the library associated technical documents, such as design rules, DRC common files, LVS, SPICE models, RC extraction, and/or layer mapping. These associated technical documents can be provided by a cooperating foundry. The IP provider 102 can select technical documents to which they can refer during design of the newly created library. The availability page further allows the IP provider 102 to input the versions of the associated technical documents used and then save the page.

Thus, the IP libraries and the information associated therewith are sorted by the login module 114 according to their basic information and availability.

Preferably, an attachment page is provided, as shown in FIG. 3B, by the login module 114 allowing attachment of library related documents. The attachment page allows IP provider 102 to provide information documents such as data sheets, application notes, release notes, silicon reports, library fact sheets, and so on. The documents can be attached by selecting “Browse” in FIG. 3B. The attachment page further allows the IP provider 102 to check the check box for related documents to classify them for internal review only. Thus, the checked documents will not be available to design companies 108.

In addition, the login module 114 provides IP providers 102 with a user interface to maintain created IP libraries. The maintenance page allows the IP provider 102 to view and/or modify their created library and the information associated therewith. The type, features, geometry, application, associated technical documents, versions used, applied for silicon status, attachments and so on are modifiable.

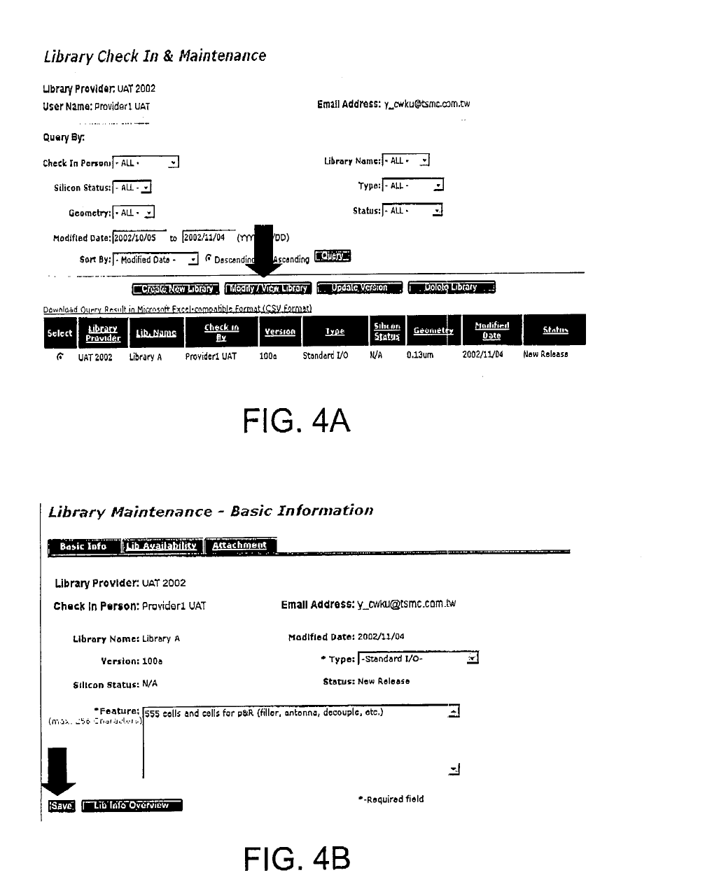

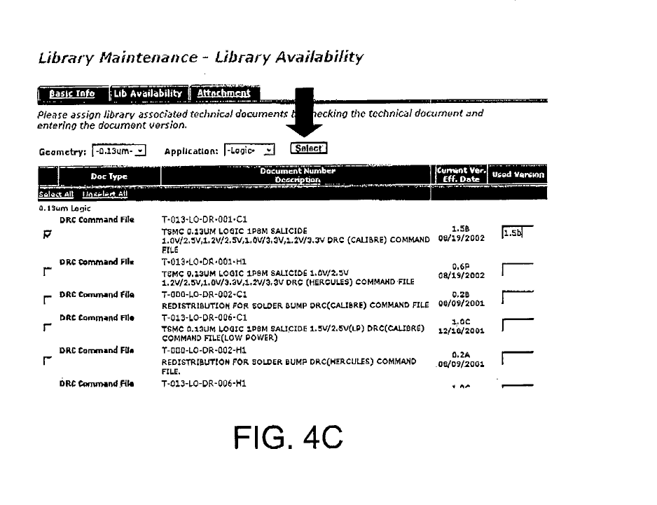

Moreover, the login module 114 provides IP providers 102 with a user interface, as shown in FIG. 4A, allowing update of library versions. The IP provider 102 is allowed to select a library and then choose “Update Version” to show an update control panel as in FIG. 4B. In FIG. 4B, the IP provider 102 inputs a required version number and feature description. Library version update information is also required for the IP provider 102 to input version update reasons and whether Engineering Change Notification (ECN) is to be forwarded to download customers. If the IP provider elects to send ECN, all customers referring to the library will be notified of the status change. Since the library version is updated, a library availability page is further provided as shown in FIG. 4C. The associated technical documents and the updated versions thereof can be re-assigned according to the updated library design.

In an embodiment, the login module 114 further allows authorized IP providers 102 to delete their existing IP libraries.

IP Library Gating

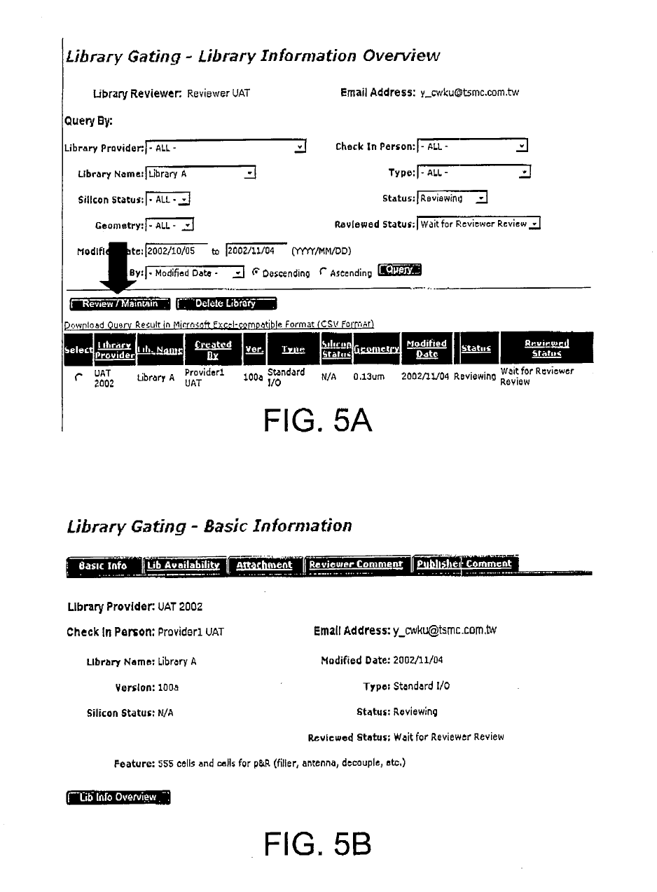

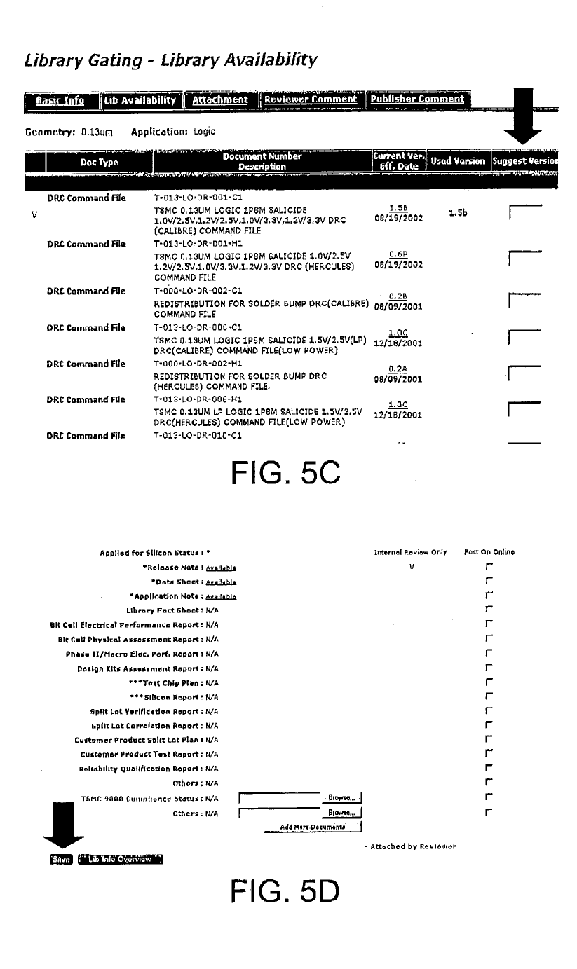

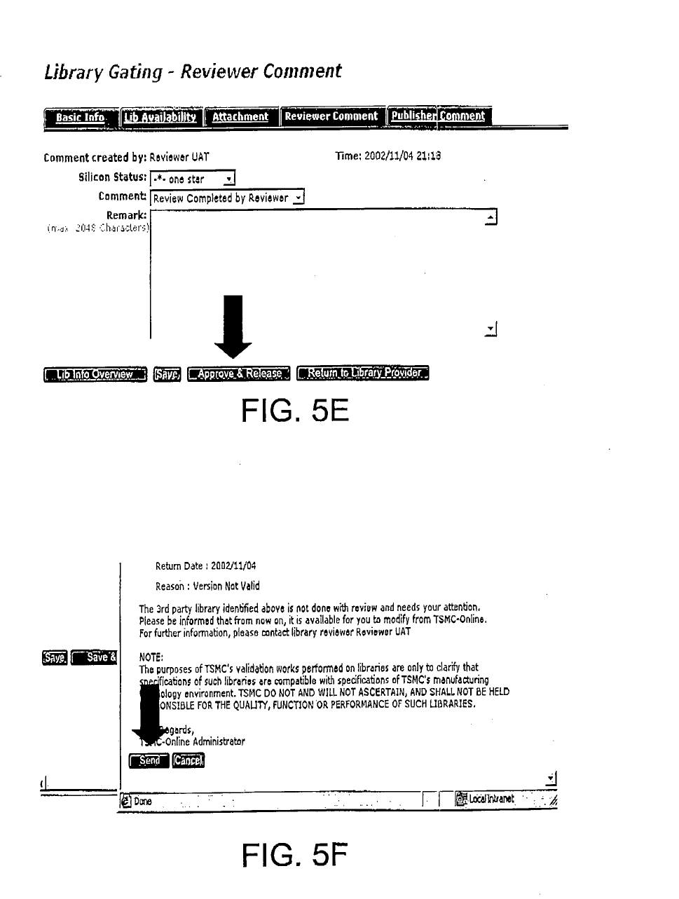

The newly created IP library and associated information input in the login module by the IP provider 102 are submitted to gating module 116. Preferably, the functions of gating module 116 include library approval/release, and library return and deletion, via Intranet or Internet. The gating module 116 provides a user interface 113, allowing an IP reviewer 104 to review the logged in library information, library availability, attachments, and engineering change notifications (ECN). An overview page, as shown in FIG. 4A, allows an IP reviewer to query a library waiting for review, by various criteria with sorting function. The gating module 116 provides the IP reviewer a basic information page, as FIG. 5B shows, showing the basic information submitted by the IP providers 102.

Preferably, in addition to the general basic information for newly created libraries, the basic information page further provides notices. “Update” library (return to library provider before), generates a “Return Comment” tag, allowing the reviewer to check the previous comments for the library. For “Delete” library (Library Provider proposed to delete the library), the library basic information is displayed with library deletion and ECN information. For “Version Update” library, the library basic information is displayed with library update version ECN information.

A library availability page can be configured through the interface by the IP reviewer 104 to display the library availability information as shown in FIG. 5C. Preferably, the reviewer's library availability page allows review and maintenance of specific library availability. The reviewer's library availability page lists the library's associated technical documents information, including: geometry, application, document type (DRM, DRC, LVS, SPICE, RCX), document number, document description, current version, effective date, used version (maintained by 3^{rd} party library providers), suggested version and so on. The reviewer can further input “suggest version” of the selected technical documents on the page.

An attachment page can be viewed on the interface by the IP reviewer 104, listing library attachment information allowing the Reviewer to review and/or maintain specific library attachments, as FIG. 5D shows. The reviewer's Library attachment page preferably lists attachments with internal review only information. As well, “Posted on Online” is also provided for IP reviewers to set which documents can be shown to design companies 108. The attached reports include data sheets, application notes, library fact sheets, release notes, silicon reports, test chip plan, test chip spec, and others, and the reviewer can attach documents under the Others category.

The gating module 116 provides the reviewer 104 with a Comments page as shown in FIG. 5E. The reviewer 104 can leave comments and remarks on the library. The IP reviewer 104 can save, approve/release, or return to the library from the Comments page. Preferably, the content of the remarks is sent as e-mail to the library provider 102. If the IP reviewer 104 approves the library, the library and the information associated therewith will be submitted to the posting module 118. If the IP reviewer 104 rejects the library, a return Comments page (not shown) is further provided by the gating module 116 allowing the IP reviewer 104 to leave and send the rejection comments in a notification e-mail for the IP provider 102. A rejection summary for the IP provider is shown in FIG. 5F, listing the status of the library and rejection reasons.

In addition, the authorized IP reviewer is further allowed to delete libraries. A deletion information page is shown on the interface allowing the authorized IP reviewer to leave reasons for library deletion.

Preferably, for the rejected libraries, the IP database 130 maintains the changed record and the latest physical documents, but not the historical physical documents. IP reviewers can keep the historical rejected physical documents in local storage.

IP Library Posting

The posting module 118 provides a user interface 117 allowing an IP publisher 105 to log on via intranet or Internet. A publisher overview page is provided, allowing the IP publisher 105 to query existing libraries by various criteria with sorting function. The criteria can be library provider name, check-in person, library name, version, geometry, type, online grade, status, reviewed status, creation date and so on. A basic information page for library posting is then displayed on the interface 117 listing the selected library and the information associated therewith, such as library provider name, library name, version, type, geometry, online grade, creation date or last modified date, status, review status, and so on. An availability page, an attachment page, and a reviewer Comments page allowing the publisher also allow the publisher 105 to view the associated library information and reviewer's comments.

A publisher Comments page is provided by the posting module 118 allowing the publisher 105 to input the comments and remarks on the library. After the publisher 105 provides the comments and remarks, the library and the information associated therewith can be classified by the publisher 105 as approved for posting or saved but not yet posted. Preferably, when the library is approved for posting, a notice will be sent to the library provider or reviewer. Generally, the publisher 105 is only granted posting privileges and is not authorized to modify the library and the information associated therewith.

All of the approved libraries and the information associated therewith are stored in the database 130 for further application by the design portfolio management server 140.

Thus, IP libraries provided by various IP providers are sorted by predetermined criteria and then further reviewed by IP reviewers and IP publishers by way of IP management server 110.

Design Portfolio Creation, Sharing, Administration and Monitoring

Since IP libraries provided by various IP providers are verified and stored in the database 130, a customized design portfolio service is provided accordingly.

As shown in FIG. 1, the design portfolio management server 140 accesses approved IP libraries in database 130. More preferably, the database 130 also stores technology documents provided by a cooperating foundry 106 via a technology document server 120. The technology documents are developed by the foundry 106 regarding both IC design and IC fabrication, which support IC design.

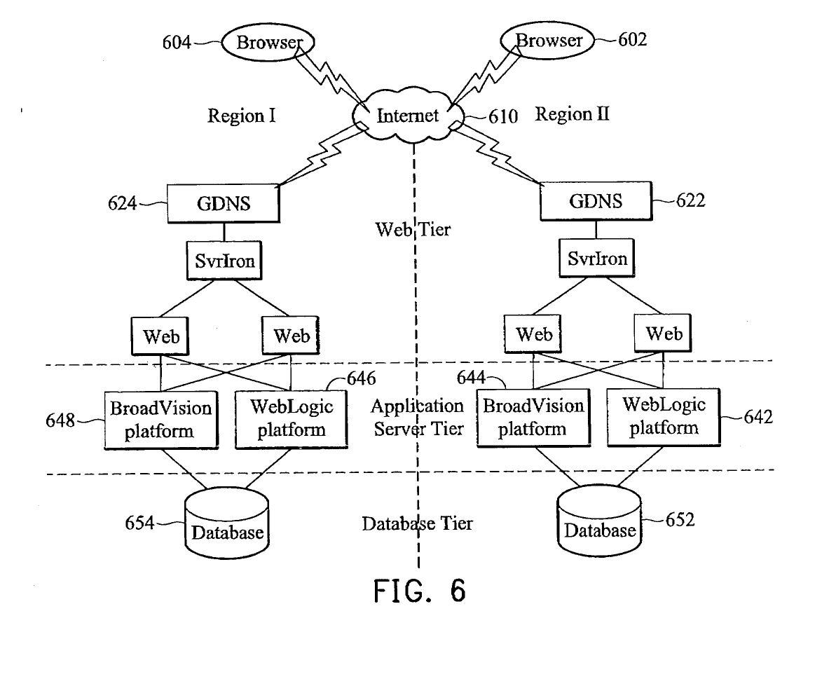

Since design customers may distribute over various locations, dual- or multi-site architecture of web tier, application server tier, and database tier can be built providing real-time response and load balancing. Exemplary dual site architecture is shown in FIG. 6. The browsers 604 and 602 in region I and II respectively are directed to corresponding local GDNS (Global Directory Mapping Server) 624 and 622. Two duplicate databases (652 and 645) and application servers (642, 644, 646, and 648) are built on region I and II respectively. Commercial platforms, such as those provided by BroadVision, Inc. and WebLogic, provided by BEA Systems, can be applied for the application server tier in an embodiment.

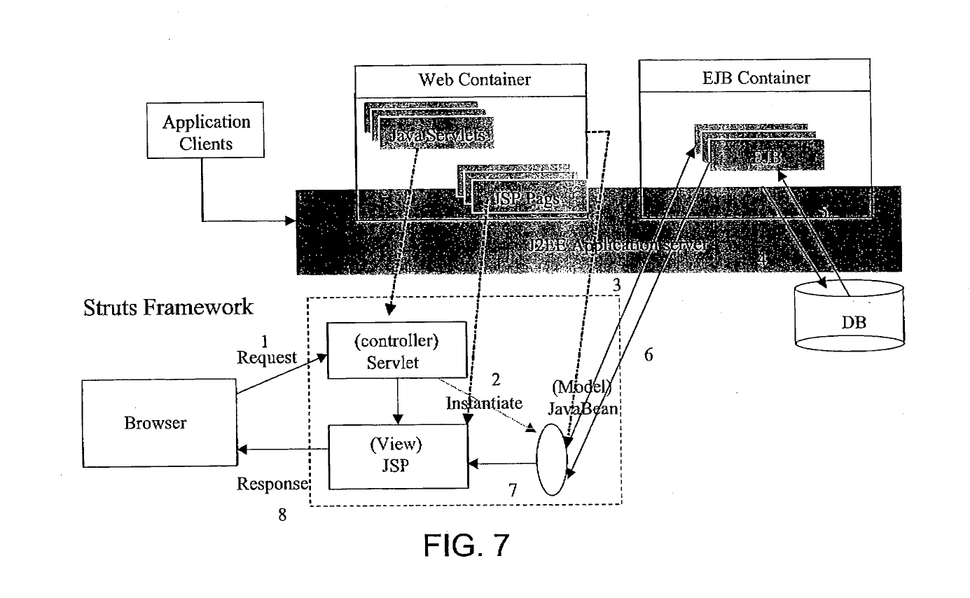

In a preferred embodiment, Java based J2EE (Java 2 Platform, Enterprise Edition) architecture and Struts framework are implemented for flexibility and expandability, as shown in FIG. 7. The design portfolio management system architecture can be built based on the Model-View-Controller (MVC) design paradigm known as J2EE Model 2. Design portfolio management server can be programmed with access the database by JDBC which translates between the database and Java application. User interface on the Web can be built with Java Servlets to provide JSP (JavaServer Pages).

As shown in FIG. 1, a general system structure for customized design portfolio is provided. The design portfolio management server 140 allows authorized design companies 108 to log onto via the Internet 142 to build a customized design portfolio including IP libraries and/or technology documents.

The design portfolio management server 140 is linked to the database 130, preferably containing a security engine module, a rule engine module, a search engine module, a notification engine module and a sharing engine module. The design portfolio management server 140 provides a website and user interface (UI) for terminal users to link to via the Internet and interactively access via a Web browser. Terminal users are, preferably, cooperating IC design companies or IC design customers (108) authorized to access the website. The preferred database 130 comprises a depository database storing pre-classified technology documents and IP libraries, and a metadata database storing the meta information of the technology documents and IP libraries in the depository database.

The design portfolio management server 140 provides a site and interactive user interface with specific functionalities allowing IC design companies 108 to build, monitor and maintain their own design portfolio from numerous technology documents and IP libraries. The security engine authenticates the identification of the IC design company 108 compared with predetermined customer information. The authorized design company is allowed to create a new and exclusive design portfolio for the new design comprising technology documents provided by a foundry and IP libraries provided by the 3rd party IP vendors. The design portfolio management server 140 accesses the database 130 according to requests, displaying an overview of the technology documents and IP libraries on the Web page for selection.

The verified technology documents and approved IP libraries are initially classified by technology document server 120 and IP management server 110 respectively, and stored in the database 130 according to different technologies, such as geometry levels and IC product characteristics. A new portfolio creation page is provided for creation of a portfolio for a new product. Preferably, one geometry level is chosen, such as 0.25 μm from 0.35 μm, 0.25 μm, 0.22 μm, 0.18 μm, 0.15 μm, or 0.13 μm from a geometry list. After that, a list of various types of IC products is shown, allowing selection by the design company 108. Available IC product application, e.g. Logic, MS/RF, CIS, 1TRAM, or EmbFlash, and electrical characteristics, can be chosen accordingly. In addition, various key electrical characteristics of the chosen product can be listed for further selection.

After the technology-related geometry and product applications are chosen, the preliminary technology definition is completed. The search engine of the design portfolio management server 140 accesses the database 130 according to the technology definition to provide a page of related technology documents and a page of related IP libraries for consideration. The design company 108 can select required technology documents and IP libraries from corresponding Web pages and save the new portfolio including selected documents and IP libraries. The design company 108 is preferably allowed assigning a filename and description of the customized design portfolio. In addition, the interface also allows the design company 108 to choose whether to receive Engineering Change Notifications (ECN) for portfolio monitoring.

Moreover, the design portfolio management server 140 further allows the design company 108 to share the portfolio within a design team by means of the sharing engine. The sharing engine allows authorized users to share their portfolio with others, e.g. team members. A design company can provide a list of team members in advance so that, after building a portfolio, the key designer in the design company can select members from the list with whom to share the portfolio, hereinafter referred to as shared users. Preferably, the sharing engine of the design portfolio management server 140 is programmed such that the shared users can only view shared portfolios, without update, delete, or add privileges.

The design portfolio management server 140 further allows authorized users to edit or manage the portfolio. A maintenance Web page is provided allowing authorized users to add, delete, and update technology documents and IP libraries, but not shared users. Authorized IC designers can easily maintain a customized design portfolio regarding a new IC product via the interactive website provided by the design portfolio management server 140.

Additionally, the design portfolio management system 140 provides engineering notification of document status changes (ENC). In a preferred embodiment, when a customized design portfolio of certain technology documents and IP libraries has been created, the notification engine of the management server 140 monitors the version status of every document and IP library in the portfolio. When the selected version of a document or an IP library in the portfolio is updated, the notification engine sends a notification to the owner, i.e. the design company 108, by means such as e-mail. The notification engine forwards the portfolio creator and the shared members a notification, e.g. via email, of document obsolescence, version conflict, or new version availability. The notification engine further provides a notification on the overview Web page when any authorized team member logs onto the website. Notifications are preferably shown on the Web page with corresponding indicators when the users access portfolios online.

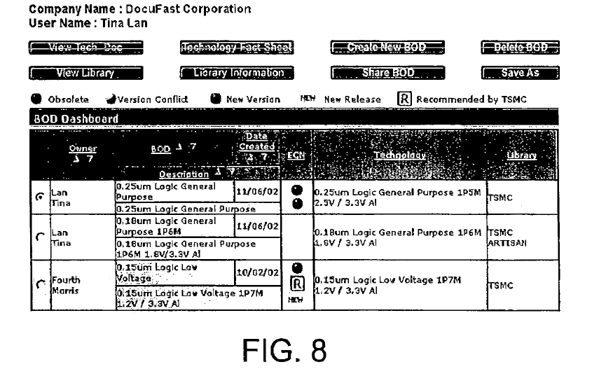

In a preferred embodiment, when a user logs onto the website, a list is displayed showing portfolios that the user can access. A column of notification, i.e. ECN, is displayed, listing the status of documents and IP libraries in each portfolio. FIG. 8 shows a Web page displaying a portfolio list with notification indicators. Preferably, each color of the indicator lights represents different status. For example, a blue light can indicate a new version of a document is available, a yellow light can indicate version conflict, and a red light can indicate that at least one document or IP library in the portfolio has been rendered obsolete. Indicators can also be symbols or characters, such as “R”, which can indicate recommendation by foundry and “New”, which can indicate there is a newly released document or library since the portfolio's creation or the most recent modification thereof. Users can easily recognize status changes.

Further, the selected portfolio can be viewed in detail with indicators representing document and/or library status. Preferably, remarks are also provided briefly describing changes in status. Preferably, authorized users are allowed to receive notification e-mail and add, delete, or update technology documents and IP libraries according to the notification indicators. Shared users can only receive notification e-mails and view the portfolio with indicator notification, with no add, delete, or update privileges.

In a preferred embodiment, design portfolio management server 140 allows authorized users to download the fact sheet, technology document and/or IP library of the portfolio. As FIG. 1 shows, the design portfolio management server 140 can directly access the database 130 according to an authorized user's request to download required information. In addition, the design portfolio management server 140 can also direct the request to a file server 160 allowing the user to download required information via a FTP sever 162. Moreover, authorized users are allowed to access the FTP server 162 directly to download the fact sheet, technology document and/or IP library of the portfolio. Preferably, the information is downloaded in CSV format.

Accordingly, the above system and method flow integrates and verifies IP libraries provided by various IP providers/vendors. IC companies are further provided with easy management and monitoring of foundry technology documents and 3^{rd} party IP libraries regarding their design by creating a customized design portfolio. The service for customized design portfolio management provided by the present invention saves design companies the time and manpower spent managing technology documents and IP libraries.

While the invention has been described by way of example and in terms of the preferred embodiments, it is to be understood that the invention is not limited to the disclosed embodiments. To the contrary, it is intended to cover various modifications and similar arrangements (as is apparent to those skilled in the art). Therefore, the scope of the appended claims should be accorded the broadest interpretation so as to encompass all such modifications and similar arrangements.

What is claimed is:

1. A system for IP library management, comprising:
an IP management server programmed with:
a login module allowing a plurality of IP 4 providers to upload and maintain IP libraries and sort the uploaded IP libraries by a plurality of criteria;
a gating module for reviewing the uploaded IP libraries to assess approvability;
a posting module for posting the approved IP libraries; and
a database for storing the IP libraries.

2. The system as claimed in claim 1, wherein the uploaded IP library comprises basic information, availability, and attachments for the IP library.

3. The system as claimed in claim 2, wherein the basic information for the IP library comprises name, type, version, and features.

4. The system as claimed in claim 2, wherein the availability for the IP library comprises geometry, application, associated technical documents, and versions used for the IP library.

5. The system as claimed in claim 2, wherein the attachments for the IP library comprise data sheets, application notes, release notes, silicon reports, and/or library fact sheets.

6. The system as claimed in claim 1, wherein the login module provides a user interface allowing the IP providers to modify and/or update the IP libraries.

7. The system as claimed in claim 1, wherein the gating module provides a user interface allowing a reviewer to review and/or modify the basic information, availability, and attachments for the IP library and input comments and remarks on the IP, thereby compiling a record.

8. The system as claimed in claim 1, wherein the gating module sends a notification to the IP provider when the provided IP library has not been approved.

9. The system as claimed in claim 1, wherein the posting module provides a user interface allowing a publisher to review the approved IP library.

10. The system as claimed in claim 1, wherein the posting module sends a notice to the IP provider when the IP library is approved for posting.

11. A method for IP library management, comprising the steps of:
providing a IP library and information associated therewith;
sorting the IP library and the information associated therewith by predetermined criteria;
reviewing the IP library and the information associated therewith to assess approvability; and
posting the approved IP library and the information associated therewith online.

12. The method as claimed in claim 11, wherein the IP library and the information associated therewith comprise basic information, availability, and attachments for the IP library.

13. The method as claimed in claim 12, wherein the basic information comprises name, type, version, and features.

14. The method as claimed in claim 12, wherein the availability for the IP library comprises geometry, application, associated technical documents, and version used.

15. The method as claimed in claim 12, wherein the attachments for the IP library comprise data sheets, application notes, release notes, silicon reports, and/or library fact sheets.

16. The method as claimed in claim 12, wherein the IP library is sorted according to the basic information and the availability.

17. The method as claimed in claim 11, further comprising sending the IP provider a notification when the IP library has not been approved.

18. A customized design portfolio management system, comprising:
a database storing a plurality of pre-classified technology documents, IP libraries, and meta information associated therewith; and
a design portfolio management server programmed with a rule engine, search engine, security engine, and notification engine, allowing a terminal user to create a customized design portfolio;
wherein the security engine authenticates user identification, the search engine searches the database according to the user's selection to create the customized design portfolio, the rule engine identifies the status of the documents and IP libraries in the document metadata database, and the notification engine monitors the status of the customized design portfolio, sending notification when the status changes.

19. The system as claimed in claim 18, wherein the technology documents and IP libraries are pre-classified based on fabrication geometry and electrical characteristics.

20. The system as claimed in claim 18, wherein the design portfolio management server further allows the user to add and/or delete technology documents and IP libraries to or from the design portfolio.

21. The system as claimed in claim 18, wherein the design portfolio management server further provides a sharing engine allowing the user to share the customized portfolio with pre-defined authorized user privileges.

22. The system as claimed in claim 21, wherein the notification engine provides notification to the shared users when the status changes.

23. The system as claimed in claim 18, wherein the notification engine further provides indicators in the interface showing status changes in portfolio documents and/or IP libraries.

24. The system as claimed in claim 23, wherein the indicators signify documents/libraries updates, version conflicts, obsolescence and/or newly released or recommended documents/libraries.

25. The system as claimed in claim 24, wherein the indicators are indicator lights, symbols and/or characters.

26. The system as claimed in claim 24, wherein the design portfolio management server further allows the user to update the document and/or IP library to a new version.

27. A system for customizing a design portfolio, comprising:
an IP library management server allowing a plurality of IP providers to upload IP libraries and verify and sort the uploaded IP libraries;
a technology document server allowing a foundry to upload technology documents and verify and sort the uploaded technology documents;
a database storing the verified technology documents, IP libraries and meta information associated therewith; and
a design portfolio management server providing a terminal user with access to the verified technology documents and IP libraries in the database for creation of a customized design portfolio thereby, and further monitoring the customized design portfolio to send notification when the portfolio status changes.

28. The system as claimed in claim 27, wherein the IP library management server is further programmed with:
a login module allowing the IP providers to upload and maintain the uploaded IP libraries and sort the uploaded IP libraries by a plurality of criteria;
a gating module for reviewing the uploaded IP libraries to assess approvability; and
a posting module for posting the approved IP libraries to the design portfolio management server.

29. The system as claimed in claim 28, wherein the uploaded IP library comprises basic information, availability, and attachments for the IP library.

30. The system as claimed in claim 29, wherein the basic information for the IP library comprises name, type, version, and features.

31. The system as claimed in claim 29, wherein the availability for the IP library comprises geometry, application, associated technical documents, and versions used for the IP library.

32. The system as claimed in claim 29, wherein the attachments for the IP library comprise data sheets, application notes, release notes, silicon reports, and/or library fact sheets.

33. The system as claimed in claim 28, wherein the login module provides a user interface allowing the IP providers to modify and/or update the IP libraries.

34. The system as claimed in claim 28, wherein the gating module provides a user interface allowing a reviewer to review and/or modify the basic information, availability, and attachments for the IP library and input comments and remarks regarding the IP, thereby compiling a record.

35. The system as claimed in claim 28, wherein the gating module sends a notification to the IP provider when the provided IP library has not been approved.

36. The system as claimed in claim 28, wherein the posting module provides a user interface allowing a publisher to review the approved IP library.

37. The system as claimed in claim 28, wherein the posting module sends a notice to the IP provider when the IP library is approved for posting.

38. The system as claimed in claim 27, wherein the technology document server sorts the uploaded technology documents based on fabrication geometry and electrical characteristics.

39. The system as claimed in claim 27, wherein the design portfolio management server is further programmed with a rule engine, search engine, security engine, and notification engine, allowing a terminal user to create a customized design portfolio;
wherein the security engine authenticates user identification, the search engine searches the database according the user's selection to create the customized design portfolio, the rule engine identifies status of the documents and IP libraries in the document metadata database, and the notification engine monitors the portfolio status, sending notification when status changes.

40. The system as claimed in claim 39, wherein the design portfolio management server further allows the user to add and/or delete technology documents and IP libraries to or from the design portfolio.

41. The system as claimed in claim 39, wherein the design portfolio management server further provides a sharing engine allowing the user to share the customized portfolio with pre-defined authorized user privileges.

42. The system as claimed in claim 41, wherein the notification engine provides notification to the shared users when status changes.

43. The system as claimed in claim 42, wherein the notification engine further provides indicators in the interface showing status changes in portfolio documents and/or IP libraries.

44. The system as claimed in claim 43, wherein the indicators signify documents/libraries updates, version conflicts, obsolescence and/or newly released or recommended documents/libraries.

45. The system as claimed in claim 44, wherein the design portfolio management server further allows the user to update the document and/or IP library to a new version.

46. The system as claimed in claim 43, wherein the indicators are indicator lights, symbols and/or characters.
